(19) United States
(12) Patent Application Publication
(10) Pub. No.: US 2008/0296319 A1
(43) Pub. Date: Dec. 4, 2008

(54) Dispenser For Liquid and/or Pasty Masses

(76) Inventors: Alfons Bockmann, Dinklage (DE); Gunter Pohlmann, Lohne (DE)

Correspondence Address: COLLARD & ROE, P.C., 1077 NORTHERN BOULEVARD, ROSLYN, NY, 11576, US

(21) Appl. No.: 12/086,539

(22) PCT Filed: Nov. 24, 2006
(86) PCT No.: PCT/EP2006/068872

§ 371 Date: Jul. 21, 2008

(30) Foreign Application Priority Data
Dec. 16, 2005 (DE) 10 2005 060 752.7
Mar. 24, 2006 (DE) 10 2006 013 789.7

(51) Int. Cl. B05B 11/00

(52) U.S. Cl. 222/372; 222/380; 222/378

(57) ABSTRACT

The invention relates to a dispenser (1) for liquid and/or pasty masses, comprising a pump chamber (9) with an inlet (10) and an outlet valve (11) and a dispenser head (12), wherein the dispenser head (12) is provided with an essentially cup-shaped lower piece (8), forming a separating wall to a reservoir (2) with a return spring (5) arranged between the lower piece (8) and the dispenser head (12) which is supported at one end on the dispenser head (12) and on the lower piece (8) at the other end. According to the invention, a conventional dispenser may be improved by provision of a recessed groove (26) running in the lower piece (8) through the separating wall, radially external to the seat of the return spring (5) on the lower piece (8) in which a cover for the dispenser head (12) may be housed on operation.

The invention relates in first instance to a dispenser for liquid and/or pasty masses, comprising a pump chamber, preferably a pump chamber having an inlet valve and an outlet valve, and comprising a dispenser head, a substantially cup-shaped lower part being associated with the dispenser head, the lower part forming a partition wall with respect to a storage reservoir, and a return spring being located between the lower part and the dispenser head, the return spring being supported at one end on the dispenser head and at the other end on the lower part.

Dispensers of the kind under discussion are known. Reference is made for example to EP 0230252 B2

In regard to the known state of the art described above, a technical problem for the invention is seen in further improving a dispenser of the kind under discussion.

This problem is solved first and foremost by the subject matter of claim 1, it being provided that a trough in the lower part extends radially outwardly of the support for the return spring on the lower part, the trough being by contrast formed by the partition wall and configured to extend in a deepened manner, and a sleeve of the dispenser head being received in the trough during actuation. As a result of this configuration, a dispenser of the kind under discussion is created which is distinguished by a compact construction. The trough provided in the lower part offers space for entry of the sleeve of the pump head, so that the free peripheral edge of the pump head facing in the direction of the lower part can be brought down during actuation beneath the plane extending through the supporting surface for the return spring. In the unloaded starting position of the pump head, established by the return spring, this lower free peripheral edge of the sleeve may be located above the plane extending through the abutment surface for the return spring on the lower part, so that in the case of a configuration of this kind, in the course of actuation, during which the pump head is displaced in the direction of the lower part against the force of the return spring, this free peripheral edge of the sleeve passes through the spring abutment plane. A shorter return spring may also be used by virtue of this configuration, compared with the lengths of spring known from the known state of the art.

The subjects of the other claims are explained below with reference to the subject matter of claim 1, but may also be important in their independent formulation.

Thus in an advantageous configuration, it is provided that the trough has a V-shaped cross-section. In this way, a radially outer V-limb of the trough boundary preferably forms at the same time a securing portion for securing the lower part to the reservoir storing the medium. The V-limb forming the radially inner boundary of the trough preferably carries the disk-shaped portion of the partition wall, this latter being at the same time carrier for the inlet valve and forming at the same time a lower support for the return spring of the dispenser head. In addition, the disk-shaped central portion of the partition wall forms the pump chamber. It is in this regard more preferable for a plane extending through the bottom of the trough to extend beneath the inlet valve, as well as in addition also beneath the outlet valve. It is also provided that an abutment step for the sleeve of the dispenser head is formed in the trough and is associated with the radially outer region of the bottom. This abutment step is further preferably provided circumferentially in the trough, but may alternatively be formed only in part.

The invention further relates to a dispenser according to the features of the preamble of claim 1 or according to claim 1.

In order to develop a dispenser of this kind for a simple, assembly-friendly construction, in particular in a manner which is technically advantageous for production, it is proposed that the inlet valve and/or the outlet valve has a valve disk and that the valve disk is made by the injection moulding process, thus in particular from a thermoplastic material, such as further for example polyethylene or polypropylene. The valve disk is secured to the corresponding supporting portion, which is fixed to the housing, in such a way that lifting opening of the valve disk is effected, driven by over-pressure or under-pressure, and thus an accompanying release of the valve openings is effected. A valve configuration that is production-advantageous and cost-advantageous is provided by the configuration of the valve disk as an injection-molded component.

The subjects of the further claims are explained below with reference to the subject matter of claim 5 or with reference to the subject matter of claim 1 or with reference to a combination of the subjects of claims 1 and 5, but may also be important in their independent formulation.

Thus it is further provided that the valve disk is secured by a deforming operation to a support fixed to the housing. Thus preferably gripping or welding of the valve disk to the support is provided, for which for example ultrasound heating may be resorted to in respect of swaging to a deformed condition. Such swaging is preferably effected centrally, i.e. centrally on the valve disk. Also, welding of the valve disk may be effected, such as centrally. Alternatively, it is proposed that the disk be spot-welded to the support fixed to the housing, preferably at two diametrically opposite points, more preferably in the radially outward region.

The invention is explained in more detail below with reference to the accompanying drawing, which only illustrates three embodiments. In the drawing:

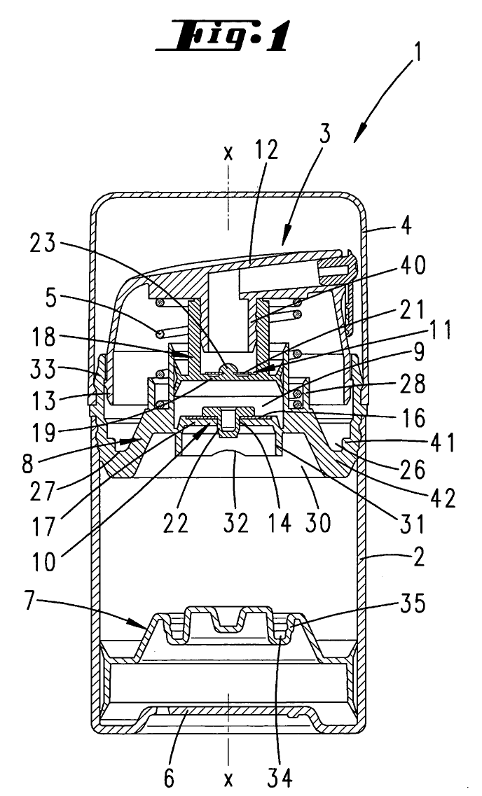

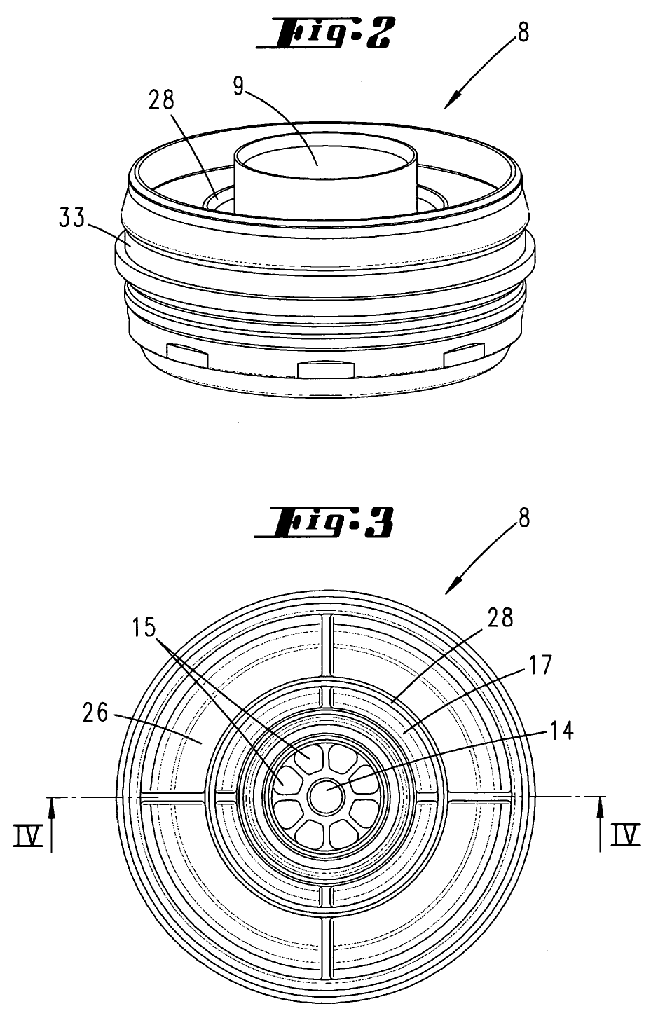

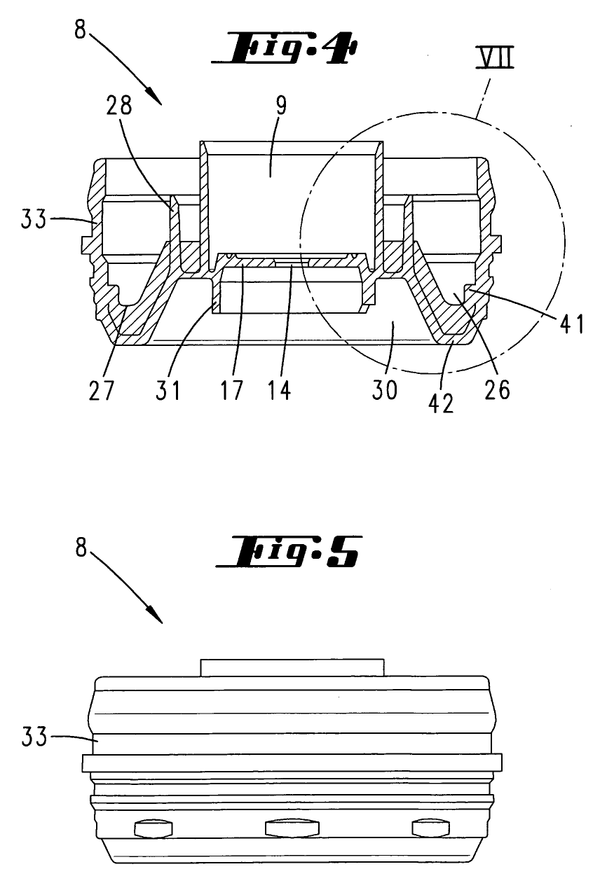

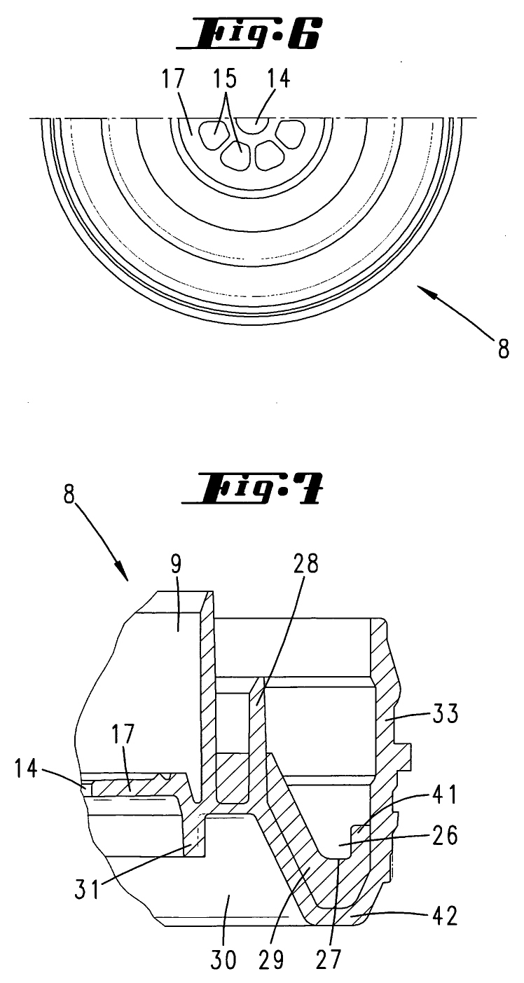

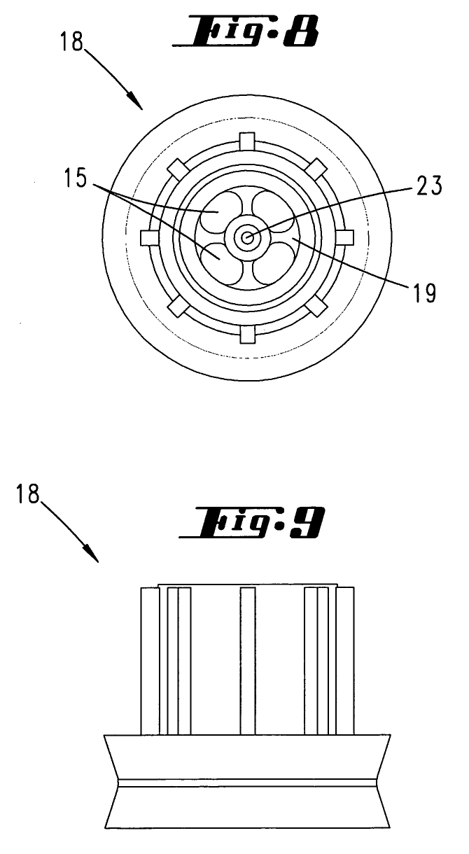

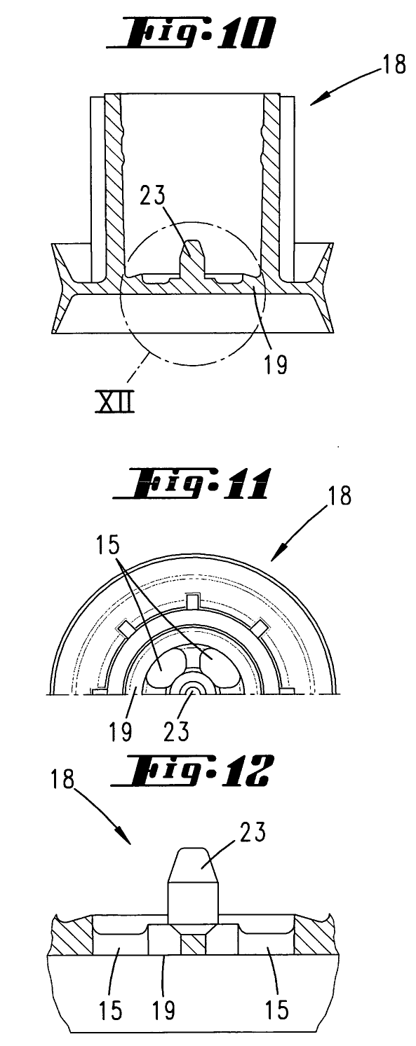

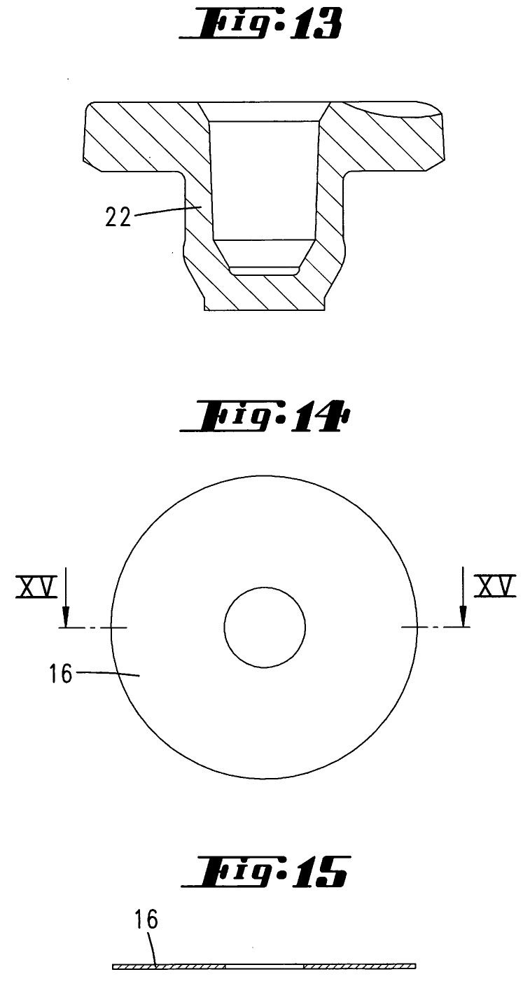

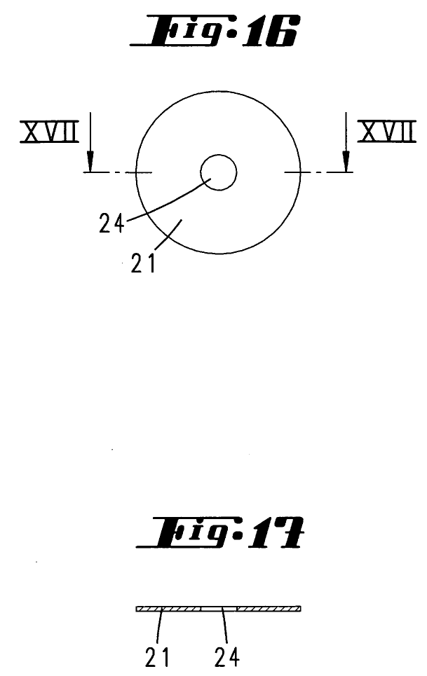

FIG. 1 shows, in longitudinal section, a dispenser of the type in question relating to a first embodiment, for the unloaded basic position of the pump head and the pump head covered over by a closure cap;

FIG. 2 shows the lower part of the dispenser of the first embodiment in perspective individual illustration;

FIG. 3 shows the lower part in plan view;

FIG. 4 shows the section on the line IV-IV in FIG. 3;

FIG. 5 shows the lower part in side view;

FIG. 6 shows the lower part in a partial view from below;

FIG. 7 shows the enlarged region VII in FIG. 4 as an extract;

FIG. 8 shows, in plan view, the pump piston of the dispenser of the first embodiment;

FIG. 9 shows the side view of this;

FIG. 10 shows the longitudinal section through the pump piston;

FIG. 11 shows the partial plan view of the pump piston;

FIG. 12 shows the enlargement of the region XII as an extract, but illustrating a section which is displaced about the axis of the member as compared with FIG. 10;

FIG. 13 shows, in sectional illustration, a stopper for securing a valve disk for the inlet valve;

FIG. 14 shows, in plan view, the valve disk of the inlet valve;

FIG. 15 shows the section on the line XV-XV in FIG. 14;

FIG. 16 shows, in plan view, the valve disk of the outlet valve;

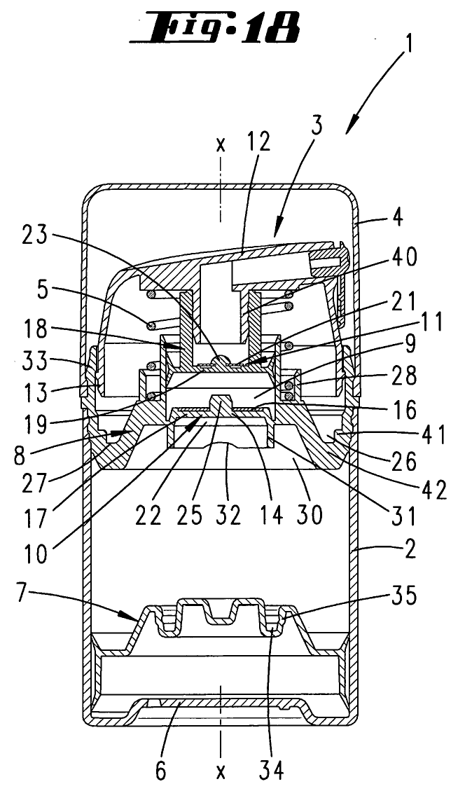

FIG. 17 shows the section on the line XVII-XVII in FIG. 16;

FIG. 18 shows an illustration, corresponding to FIG. 1, of a dispenser, but for a second embodiment;

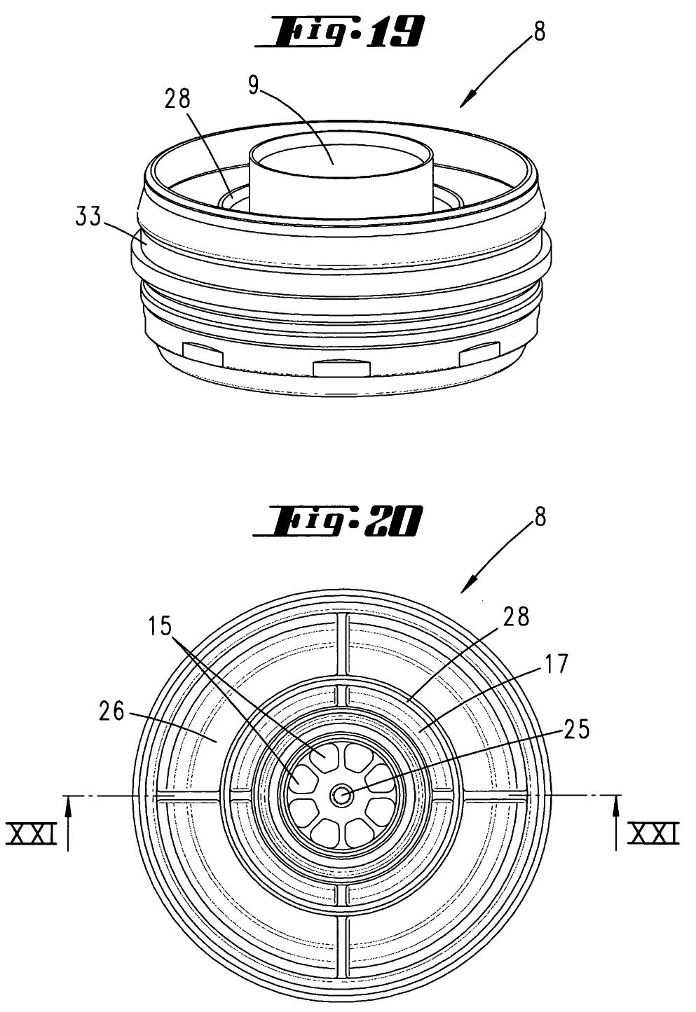

FIG. 19 shows an illustration corresponding to FIG. 2, but for the lower part of the second embodiment;

FIG. 20 shows the plan view of the lower part;

FIG. 21 shows the section on the line XXI-XXI in FIG. 20;

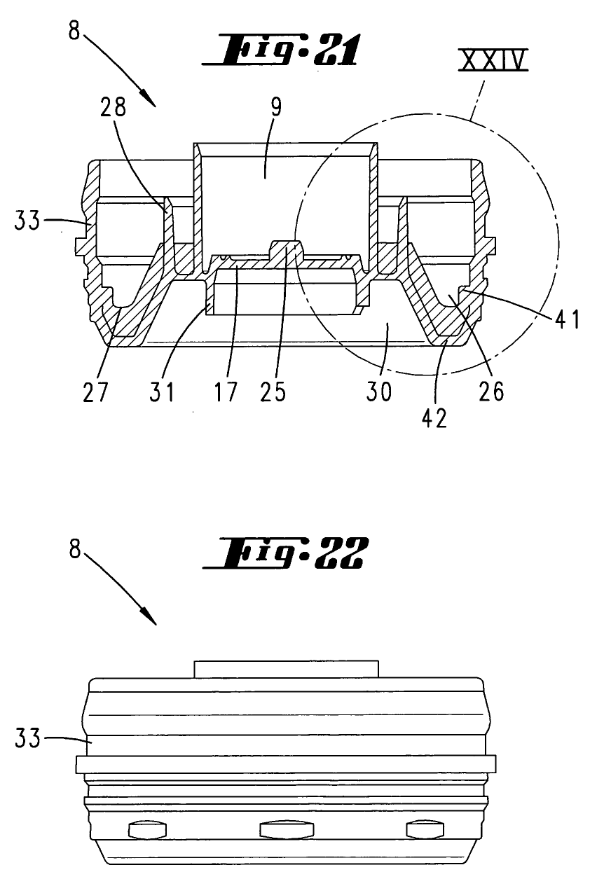

FIG. 22 shows the side view of the lower part;

FIG. 23 shows the partial view from below of the lower part;

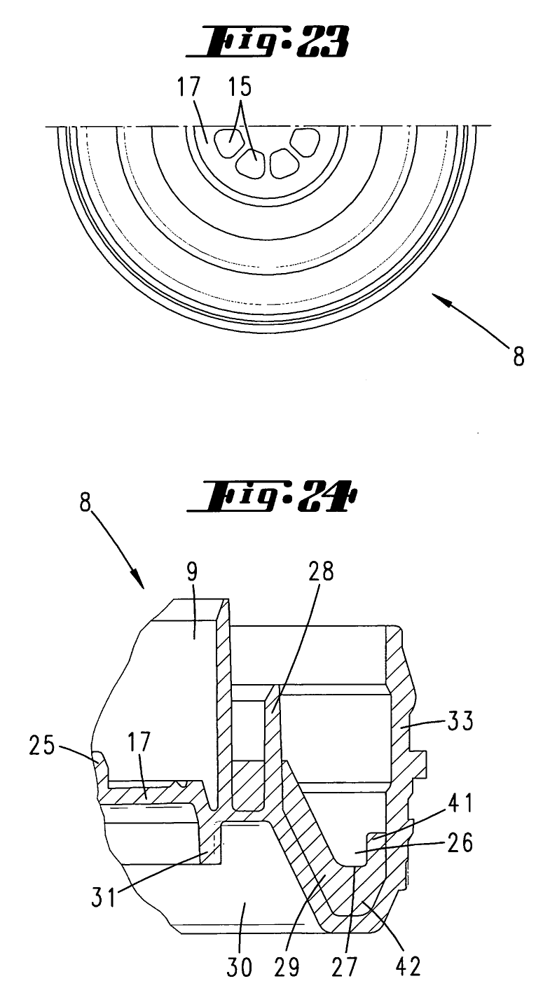

FIG. 24 shows the enlargement of the region XXIV in FIG. 21 as an extract;

FIG. 25 shows a further illustration corresponding to FIG. 1, for a third embodiment of the dispenser;

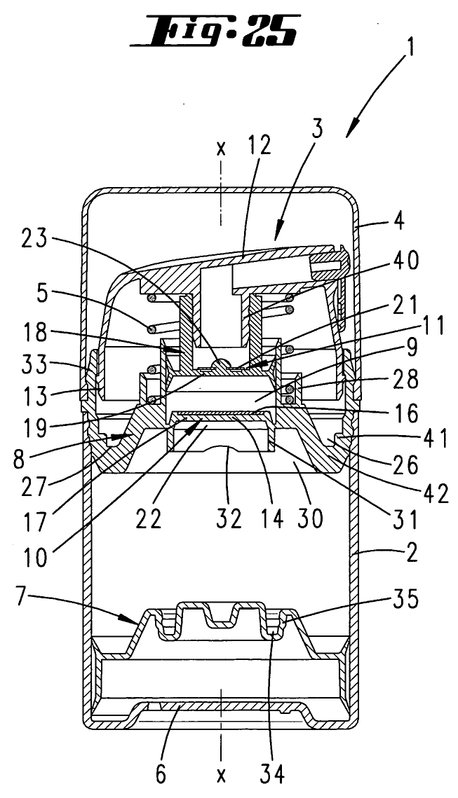

FIG. 26 shows the lower part of the third embodiment in perspective individual illustration;

FIG. 27 shows the plan view of the lower part;

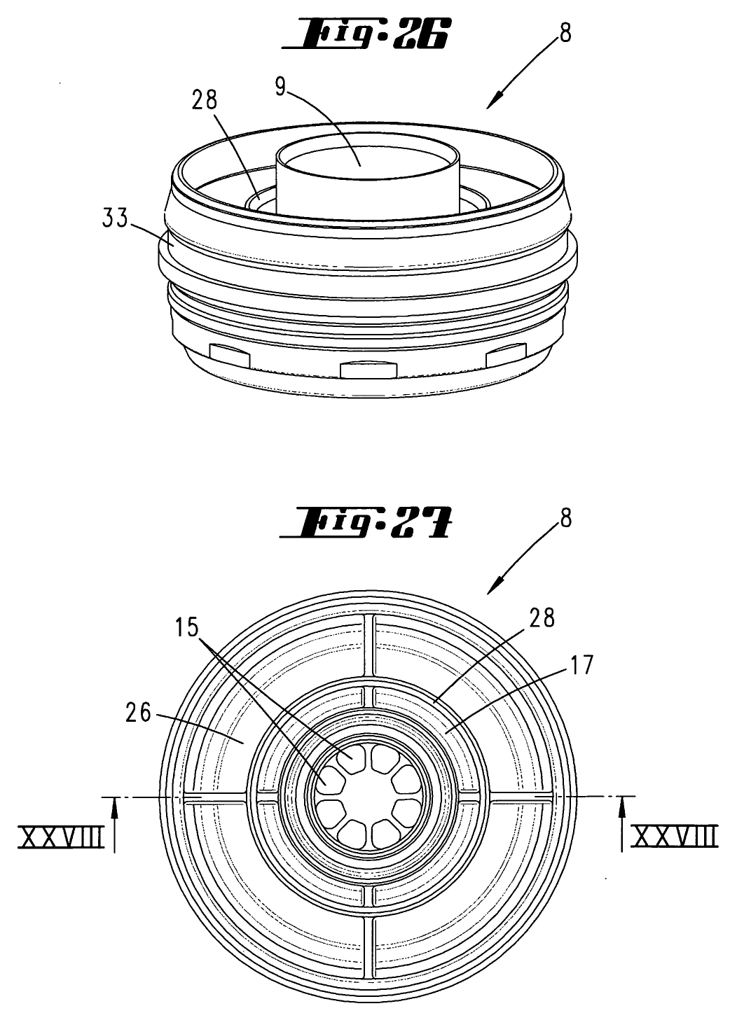

FIG. 28 shows the section on the line XXVIII-XXVIII in FIG. 27;

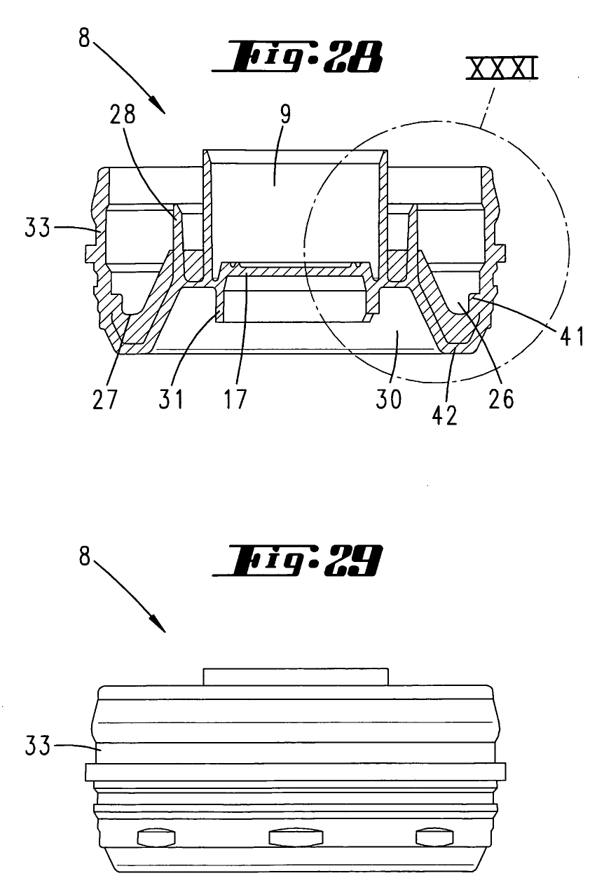

FIG. 29 shows the side view of the lower part;

FIG. 30 shows the partial view from below of the lower part;

FIG. 31 shows the enlargement of the region XXXI in FIG. 28 as an extract;

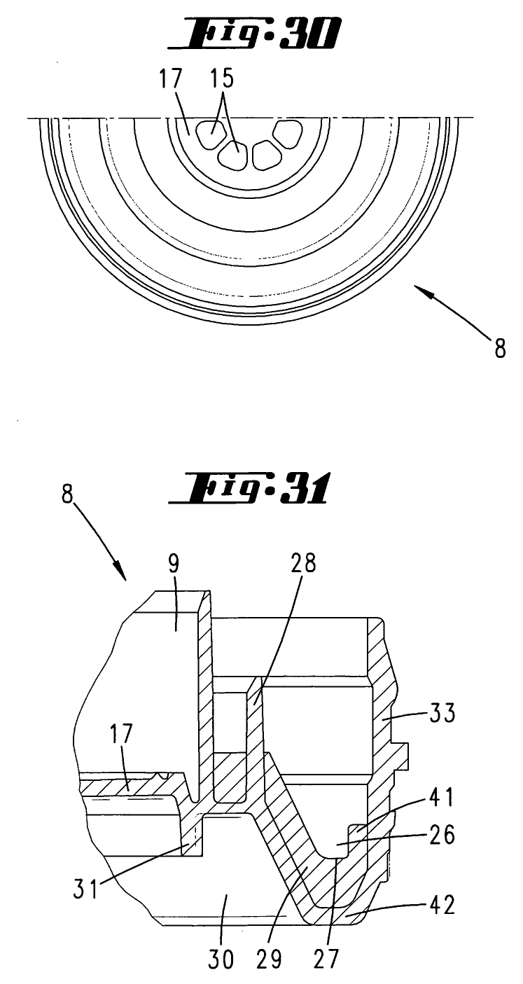

FIG. 32 shows, in plan view, the pump piston of the third embodiment;

FIG. 33 shows the side view of this;

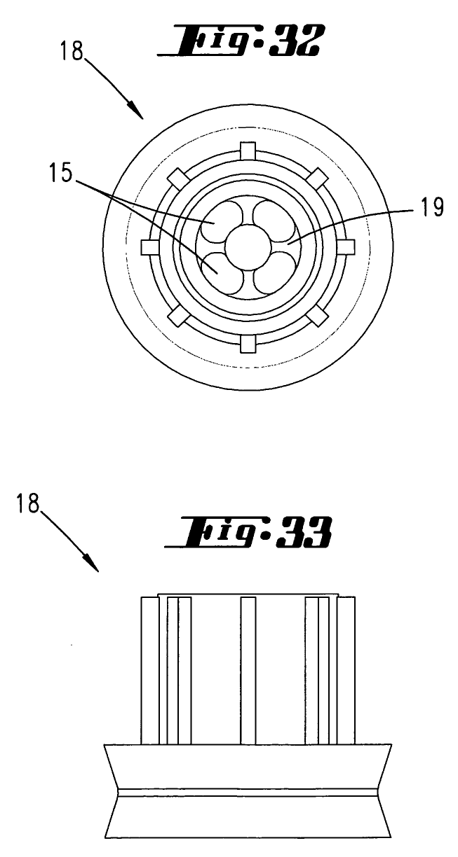

FIG. 34 shows the longitudinal section through the pump piston;

FIG. 35 shows the partial plan view of the pump piston;

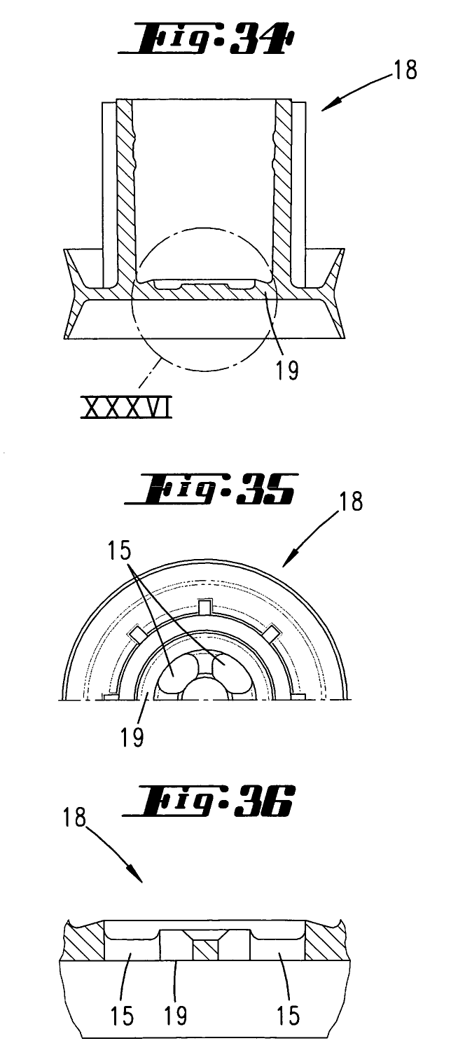

FIG. 36 shows an illustration corresponding to FIG. 12, but for the third embodiment;

FIG. 37 shows the valve disk of the third embodiment in plan view;

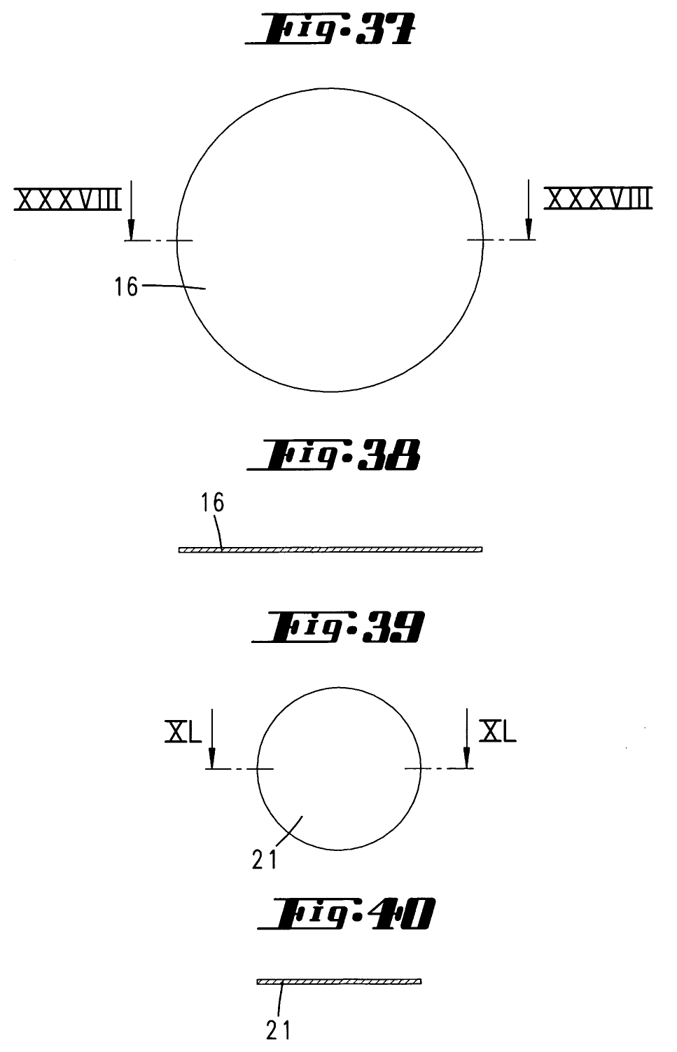

FIG. 38 shows the section on the line XXXVIII-XXVIII in FIG. 37;

FIG. 39 shows the valve disk of the outlet valve of the third embodiment, and

FIG. 40 shows the section on the line XL-XL in FIG. 39.

A first embodiment of a dispenser 1 is illustrated and described first of all with reference to FIG. 1. This is substantially assembled from a storage reservoir 2 of hollow cylindrical form and a delivery head 3 coupled to the reservoir, the head being covered over in the illustrated position of non-use by a cap 4.

The molded parts of the dispenser 1 consist for the most part of a plastics material, such as for example polyethylene, and are produced by the injection molding process. A return spring 5 forms an exception to this, this being a cylindrical metal spring.

The storage reservoir 2 has a substantially closed reservoir base 6 (apart form a venting hole). The reservoir is open in the direction of the delivery head 3.

A feeding piston 7 is positioned in the storage reservoir 2, by means of which the medium to be delivered in transported in the direction of the delivery head 3.

The delivery head 3 is substantially assembled from a cup-shaped lower part 8, which forms a partition wall with respect to the storage reservoir 2, from a pump chamber 9, which has an inlet valve 10 and an outlet valve 11, and from a dispenser head 12, which is supported on the return spring 5.

The lower part 8, the pump chamber 9, the return spring 5 and an outer wall 13 of the dispenser head 12 are disposed on a common axis x in a rotationally symmetrical manner, the axis x forming at the same time also the axis of the body of the storage reservoir 2.

The cup base 17 of the lower part 8 has a central opening 14, from which there extend in the shape of a star slit-like entry openings 15. These are covered over by a flexible closure plate 16, which forms the inlet valve 10. A stopper 22 passes through a central opening in the closure plate 16, the stopper likewise preferably being made from a plastics material and being intended for securing the closure plate 16 to the cup base 17.

Above the cup base 17, a cylindrical wall extends from the base in order to form the pump chamber 9. A pump piston 18 is mounted in the chamber for movement in the axial direction. The piston is secured to a hollow stopper portion 40 of the dispenser head 12, the portion 40 penetrating into the pump piston 18. The pump piston 18 is provided with passage openings 20 in the region of a base 19 of the piston. These openings form the outlet valve 22 together with a valve plate 21 secured on the upper side of the base 19 of the piston, i.e. the side facing away from the pump chamber 9.

The inlet and outlet valves can be triggered by pressure action and are produced by the plastics injection molding process. They preferably consist of a thermoplastic material such as polyethylene or polypropylene.

According to the first embodiment illustrated in FIGS. 1 to 17, the upper valve plate 21 associated with the outlet valve 22 is gripped onto the associated piston base 19, for which a spigot extending from the piston base 19 passes through the valve plate 21 in the region of a central opening 24. The spigot 23 is reshaped, in particular by the action of a heat source, such as for example by means of ultrasonic heating.

According to the second embodiment in FIGS. 18 to 24, a rivet-like securing of this kind may also be provided for the inlet valve 10, for which, in a configuration of this kind, a suitable spigot 25 is provided from the from the cup base 17, the spigot passing through the central opening of the lower closure plate 16.

As a further alternative, the securing of the valve plates 21 and/or 16 may also be effected, according to the third embodiment (FIGS. 25 to 40), by welding. This welding of the valve plate, which is carried out when the valve is largely closed, may either be effected centrally in the middle to the associated fixed part, or alternatively, the welding may be provided at two diametrically opposed regions of the closure plate, in particular near the edges.

The lower part 8 is furthermore formed to be bell-shaped in cross-section, as a result of which a trough 26 is formed, radially outwardly of the inlet valve 10 that is formed in the region of the lower part 8, and the bottom 27 of the trough is arranged to be at a lower level that the inlet valve 10. Accordingly, the plane of the bottom 27 of the trough is positioned beneath the plane that extends through the closure plate 16 of the inlet valve.

The bottom 27 of the trough as seen in plan view is formed substantially to be aligned with the outer wall 13 of the dispenser head 12, and accordingly forms a space for receiving the sleeve of the dispenser head 12.

The downwardly directed free peripheral edge of the sleeve or outer wall 13 of the dispenser head 12 extends in a plane directed transversely to the axis x, which, in the embodiments illustrated, always runs beneath the plane extending through the outlet valve 11 or its closure plate 21, but above the plane extending through the closure plate 16 of the inlet valve, at least in the starting position of non-use.

An abutment step 41 associated with the bottom 27 is formed in the trough 26. This starts from the radially outer region of the bottom 27 and serves to delimit an abutment for the dispenser head 12, which can move downwards. In the lowered position of the dispenser head, the free peripheral end edge of the outer wall 13 engages against the facing upper surface of the abutment step 41.

This abutment step 41 and the plane extending through the abutment surface, which extends transversely to the axis x of rotation, is positioned beneath the plane of the inlet valve, which thus is defined by the closure plate 16.

The outer wall 13 of the dispenser head 12 is displaced in the direction of the trough 26, this displacement being, as the case may be, into the deepest position, which lies beneath the plane formed by the inlet valve 10; the displacement is effected by downward displacement of the dispenser head 12 against the force of the return spring 5, the lower winding of the spring being seatingly accommodated radially outwardly on the lower part 8 by way of a partition wall 28, which is cylindrical in shape and extends from the lower part 8.

Four ribs 29 may also be formed in the trough 26, the ribs being uniformly distributed around the circumference and each suitably enclosing an angle of 90° with respect to one another. These may serve as an alternative abutment limit for the dispenser head 12.

The trough portion 42 of the lower part 8 protruding downwardly beyond the cup base 17 into the storage reservoir 2 forms a central, frustoconical space 30, into which in turn a hollow cylindrical portion 31 penetrates, protruding downwardly on the underside from the cup base 17, the portion 31 having a short axial extent compared with the trough portion 42 of the lower part 8. The downwardly facing free peripheral edge of the cylindrical portion 31 is partially provided with concave cut-outs 32.

The trough portion 42 of the lower part 8 merges radially outwardly into a sleeve-like securing portion 33 extending in the direction of the dispenser head 12. This is radially outwardly connected to the storage reservoir 2. Radially inwardly, the securing portion 33 serves for securing the dispenser head 12 while retaining axial movability of the dispenser head 12.

The feeding piston 7 is substantially matched in cross-section to the mating contour of the lower part 8, so that almost complete emptying of the storage reservoir 2 can be achieved.

An annular depression 34 in the feeding piston 7, depression 34 receiving the cylindrical portion 31 of the lower part 8, is provided, in the region of the radially outward wall, with a widened portion 35, portion 35 being, in cross-section, in the shape of a sector of a circle and partially enlarging the opening cross-section of the depression 34.

All disclosed features are (in themselves) pertinent to the invention. The disclosure content of the associated/accompanying priority documents (copy of the prior application) is also hereby included in full in the disclosure of the application, including for the purpose of incorporating features of these documents in claims of the present application.

1. Dispenser (1) for liquid and/or pasty masses, comprising a pump chamber (9), preferably a pump chamber (9) having an inlet valve (10) and an outlet valve (11), and comprising a dispenser head (12), a substantially cup-shaped lower part (8) being associated with the dispenser head (12), the lower part forming a partition wall with respect to a storage reservoir (2), and a return spring (5) being located between the lower part (8) and the dispenser head (12), the return spring being supported at one end on the dispenser head (12) and at the other end on the lower part (8), characterized in that a trough (26) in the lower part (8) extends radially outwardly of the support for the return spring (5) on the lower part (8), the trough being by contrast formed by the partition wall and configured to extend in a deepened manner, and a sleeve of the dispenser head (12) being received in the trough during actuation.

2. Dispenser according to claim 1, wherein the trough (26) has a V-shaped cross-section.

3. Dispenser according to claim 1, wherein a plane extending through the bottom (27) of the trough (26) extends beneath the inlet valve (10).

4. Dispenser according to claim 1, wherein an abutment step (41) for the sleeve of the dispenser head (12) is formed in the trough (26) and is associated with the radially outer region of the bottom (27).

5. Dispenser according to claim 1, wherein the inlet valve (10) and/or the outlet valve (11) has a valve disk (16, 21) and in that the valve disk (16, 21) is made by the injection moulding process, for example from polyethylene or polypropylene.

6. Dispenser according to claim 1, wherein the valve disk (16, 21) is gripped by or welded to a support fixed to the housing.

7. Dispenser according to claim 1, wherein the valve disk (16, 21) is gripped centrally by or welded centrally to a support fixed to the housing.

8. Dispenser according to claim 1, wherein in the case of welding of the valve disk (16, 21), this is carried out at a plurality of points.

9. Dispenser according to claim 1, wherein in the case of welding of the valve disk (16, 21), this is carried out at two points on the valve disk (16, 21) that are near the edge of the disk and are located diametrically opposite one another.
